(19) United States
(12) Patent Application Publication
(10) Pub. No.: US 2012/0042275 A1
(43) Pub. Date: Feb. 16, 2012

(54) CLONING SPECIFIC WINDOWS ON A WIRELESS DISPLAY SURFACE

(75) Inventors: Srinivasa R. Neerudu, Redmond, WA (US); Nelly Porter, Kirkland, WA (US); Casey Dvorak, Seattle, WA (US)

(73) Assignee: Microsoft Corporation, Redmond, WA (US)

(21) Appl. No.: 12/854,155

(22) Filed: Aug. 10, 2010

(51) Int. Cl. G06F 3/048

(52) U.S. Cl. 715/781

(57) ABSTRACT

Techniques are provided for cloning specific windows of a computer desktop to a wireless display surface. The user console session of a source computer and a destination computer establish a wireless communications channel. The user console session determines a specific window or windows to share with the destination computer, such that the destination computer will display the window(s) on a wireless display. The user console session extracts these window(s) and encodes them with a remote presentation protocol, then transmits the encoded window to the destination computer, such that the encoded windows are not transferred through a second user session of the source computer before being transferred to the destination computer. Upon receiving the encoded window, the destination computer decodes the encoded windows and displays them on the wireless display.

### BACKGROUND

It has been common to share a computer desktop and applications with a remote client using remote presentation protocol (RPP) technologies, such as Remote Desktop Protocol (RDP), and Independent Computing Architecture (ICA). Such shared computing systems typically are established through instantiating a user session for the RPP session on the server of the session. Where the server's screen is to be shared with a client of the session, the RPP session obtains that information from a console session that is local to the server. During the RPP session, the client transmits the keyboard presses and mouse clicks or selections to the server, and the server sends screen updates back in the other direction to the client over a network connection (e.g., the INTERNET). As such, the user of the client has the experience as if his or her computer is executing the applications locally, when in reality the client computer is only sent screenshots of the applications as they appear on the server side.

It has also been common for a computer to display images on a display device (such as a television or a monitor) via a cable, such as a composite (RCA) cable or a High-Definition Multimedia Interface (HDMI) cable. There also exists technology that enables a computer to display images on a display device wirelessly. There are many issues with displaying images on wireless devices, some of which are well known.

### SUMMARY

The present invention provides improved techniques to display screen data and enable a computer desktop-quality experience on wireless displays. As used herein, screen data may comprise images to be displayed on a monitor (such as a computer desktop), audio to be through one or more speakers, and input to a computer (such as movement of a cursor, manipulation of a multi-touch track pad, or keyboard presses). Screen data that is sent to a destination computer and output thereon will be referred to with terms such as being “displayed,” “output,” or “presented,” and this may include the output of audio through one or more speakers. Prior art techniques involve displaying a complete computer image on a wireless display. However, a common use scenario involves a user's desire to display specific windows—only a window or a few windows (such as the windows of a single application)—on the wireless display. For instance, a user may navigate to a web page that contains a video, begin playing that video, and desire to have that video displayed on a wireless display (and the audio from that video played on speakers of the wireless display). While that video is playing, the user may also desire to check his or her e-mail on his or her computer by placing a window from an e-mail program over that playing video. Even though the video is now occluded on his or her computer, the user may still desire that it still be displayed on the wireless display. It would therefore be an improvement over the prior techniques to provide techniques for displaying specific windows on wireless displays, and for removing occlusions of those windows.

As used herein, the term “wireless display” is not intended to convey that the display has no wires, but rather that there is not a continuous wire between the wireless display and the source computer that the source computer uses to transmit images to the wireless display. In an embodiment, a source computer and a destination computer that is in communication with a wireless display establish a wireless connection, and the source computer has a virtual display driver that corresponds to the wireless display (similar to how a conventional graphics display driver corresponds to a wired display of the source computer). A user who is directly using the source computer has a user console session on that source computer. In that user console session, the user executes applications. Those applications execute to produce graphics (such as an application window on a computer desktop), and to produce those graphics for the wireless display, an application instructs the virtual display driver to render graphics to a memory area or a display surface of the source computer. The source computer takes this graphical information—be it an image, or computer-executable instructions that, when executed on a processor generate an image—encodes it with a remote presentation protocol (RPP) and sends it to the wireless display from the user console session.

Furthermore, the source computer may send only specific windows of its computer desktop to the destination computer, such as those windows that make up a single application. These windows may be extracted from a computer desktop, or where they are not rendered fully on a computer desktop (such as because they are occluded by non-shared windows), another memory area in source computer. In sending only specific windows to the destination computer, the source computer may also send only specific audio to the destination computer. For instance, where a shared window comprises a playing video, and a non-shared window generates alert sounds, the source computer may send the destination computer only the audio of the playing video.

Other techniques for using a RPP to transmit data require more than one user session to do so. For instance, versions of the terminal server RPP require a client computer to connect to the source computer with a second user session. Then, to share the user console session's computer desktop with the client computer, the second user session intercepts screen data from the user console session and sends it to the client, and injects user input (e.g. cursor movements) from the client computer into the user console session.

In using the present techniques, the paradigm is changed from a conventional RPP session. A conventional RPP session comprises a user at a client computer sending input to the server and receiving images back. In contrast, under the present techniques, the user is logged into the console of the source computer where he or she makes input into the server, and then the screen data generated from that local input is transmitted to the destination computer for display.

As a result of transmitting RPP data with a single user session on the source computer, the process of the source computer encoding screen data (such as a specific window, or a specific window and corresponding audio) with a remote presentation protocol (RPP) and the display computer decoding the screen data with the RPP occurs outside of a conventional remote presentation session. That is, in a remote presentation session, a server may authorize a client's credentials, and create a separate operating system user session in which the remote presentation session occurs. In contrast, in the present invention, while wirelessly transmitted data is encoded according to a RPP, other operations commonly associated with a remote presentation session—like authentication or creating a separate operating system session—do not necessarily occur.

There exist operating systems that include sessions in addition to conventional user sessions. For instance, versions of the MICROSOFT WINDOWS operating system contain a “session 0,” in which system services are executed, but no user processes are executed. These session 0 system services may include a RPP service that encodes and transmits screen data. The discussion of this invention that discusses the use of a single user session should not be read to exclude embodiments of the invention that include non-user sessions, such as session 0.

While the primary embodiment discussed herein involves transmitting screen data to a wireless display, it may be appreciated that these techniques may be applied across other communications channels where fidelity and interactivity are constrained, including wired communications channels.

It can be appreciated by one of skill in the art that one or more various aspects of the invention may include but are not limited to circuitry and/or programming for effecting the herein-referenced aspects of the present invention; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer-readable media for displaying specific windows of a computer desktop on a wireless display surface are further described with reference to the accompanying drawings in which:

FIG. 1 depicts an example general purpose computing environment in which in which techniques described herein may be embodied.

FIG. 2 depicts an example computer system that depicts techniques for displaying images on a wireless display.

FIG. 2A depicts the sessions on a server in an example computer system where a conventional remote presentation protocol (RPP) session occurs.

FIG. 2B depicts the sessions on a server in an example computer system where displaying images on a wireless display occurs.

FIG. 3A depicts a computer desktop comprising a plurality of windows, wherein as a subset of the plurality of windows—specific windows—are to be shared.

FIG. 3B depicts the shared windows of the computer desktop of FIG. 3A as received by a destination computer the techniques of the present invention.

FIG. 4 depicts example operational procedures for extracting specific windows to be shared.

FIG. 5 depicts example operational procedures for sharing specific windows to a wireless display.

### DETAILED DESCRIPTION OF ILLUSTRATIVE EMBODIMENTS

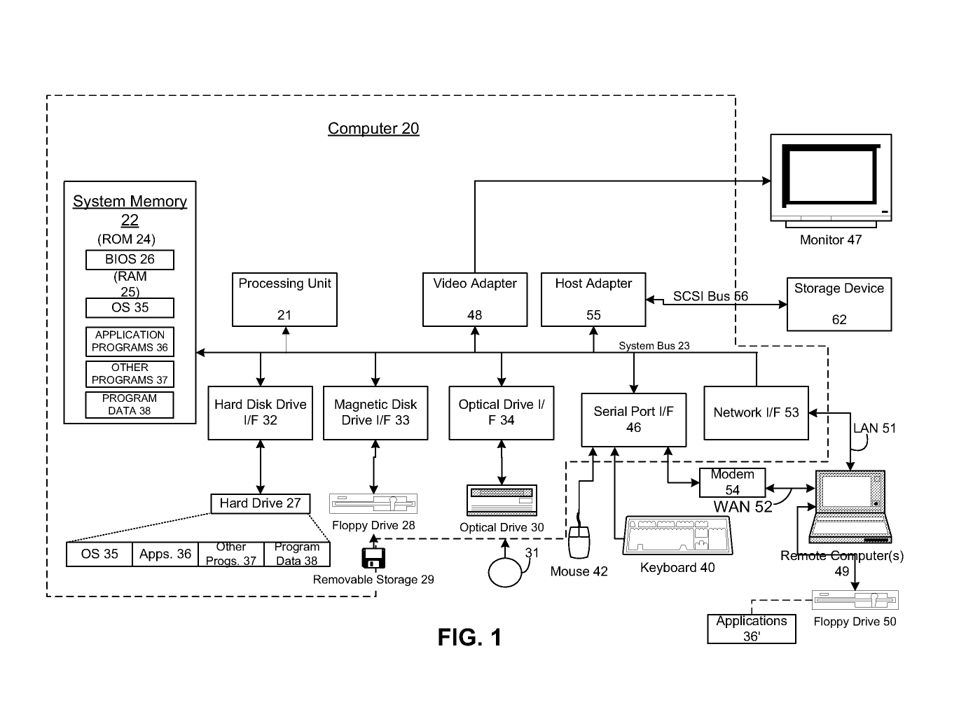

Embodiments may execute on one or more computer systems. FIG. 1 and the following discussion are intended to provide a brief general description of a suitable computing environment in which the disclosed subject matter may be implemented.

The term circuitry used throughout the description can include hardware components such as hardware interrupt controllers, hard drives, network adaptors, graphics processors, hardware based video/audio codecs, and the firmware used to operate such hardware. The term circuitry can also include microprocessors, application specific integrated circuits, and/or one or more logical processors, e.g., one or more cores of a multi-core general processing unit configured by instructions read from firmware and/or software. Logical processor(s) can be configured by instructions embodying logic operable to perform function(s) that are loaded from memory, e.g., RAM, ROM, firmware, and/or mass storage. In an example embodiment where circuitry includes a combination of hardware and software, an implementer may write source code embodying logic that is subsequently compiled into machine readable code that can be executed by a logical processor. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 1, an exemplary general purpose computing system is depicted. The general purpose computing system can include a conventional computer 20 or the like, including at least one processor or processing unit 21, a system memory 22, and a system bus 23 that communicative couples various system components including the system memory to the processing unit 21 when the system is in an operational state. The system bus 23 may be any of several types of bus structures including a memory bus or memory controller, a peripheral bus, and a local bus using any of a variety of bus architectures. The system memory can include read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are shown as connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as flash memory cards, digital video disks, random access memories (RAMs), read only memories (ROMs) and the like may also be used in the exemplary operating environment. Generally, such computer readable storage media can be used in some embodiments to store processor executable instructions embodying aspects of the present disclosure.

A number of program modules comprising computer-readable instructions may be stored on computer-readable media such as the hard disk, magnetic disk 29, optical disk 31, ROM 24 or RAM 25, including an operating system 35, one or more application programs 36, other program modules 37 and program data 38. Upon execution by the processing unit, the computer-readable instructions cause the actions described in more detail below to be carried out or cause the various program modules to be instantiated. A user may enter commands and information into the computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A display 47 or other type of display device can also be connected to the system bus 23 via an interface, such as a video adapter 48. In addition to the display 47, computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

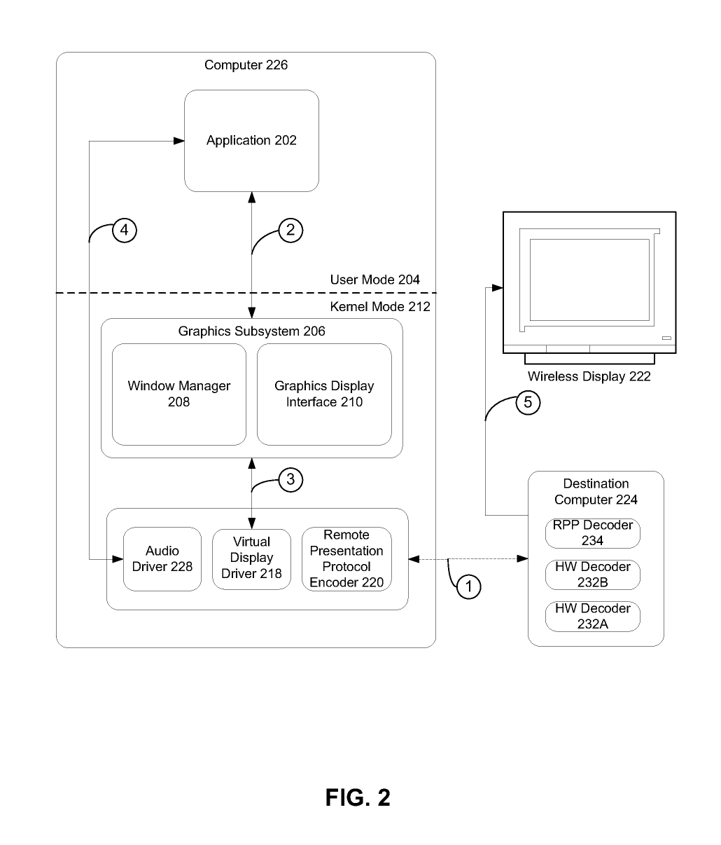

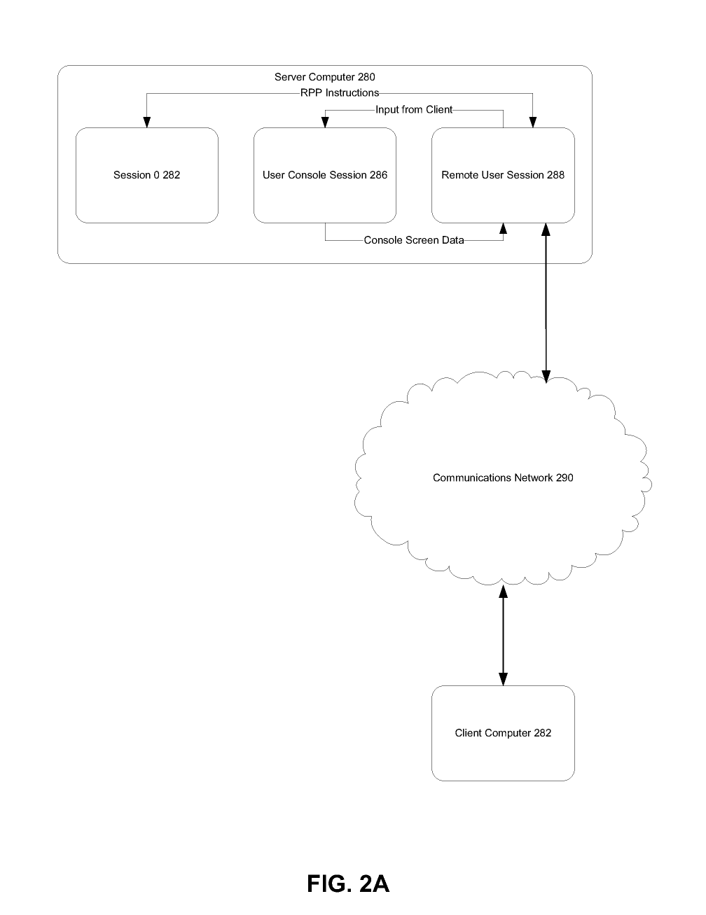

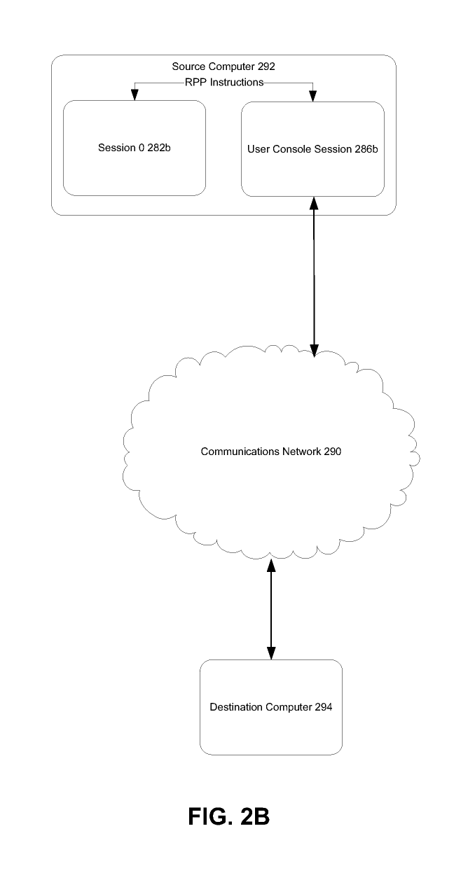

FIG. 2 depicts an example computer system that emphasizes the components involved in generating computer graphics and displaying graphics as well as other screen data on a wireless display. The computer system of FIG. 2 may be effectuated using the computer of FIG. 1. The architecture of components depicted in FIG. 2 are similar to the architecture of some versions of the MICROSOFT WINDOWS operating system.

A user's session, including application 202, executes in user mode 204—a mode where processes cannot access the memory of other processes save for through application programming interface (API) functions or commands. Processes in user mode also cannot interfere with interrupts or context switching. When application 202 draws to a display surface, application 202 sends a graphics API command to graphics subsystem 206. Graphics subsystem 206 comprises window manager 208, which controls the placement and appearance of windows within an operating system's desktop, and graphics device interface (GDI) 210 (which may include graphics functions such as WINDOWS GDI commands, DIRECTX commands and composition), which is responsible for representing graphical objects and transmitting to an output device, such as a computer monitor. Graphics subsystem 206 executes in kernel mode 212 (sometimes referred to as “system mode”), a mode in which any process may execute any instruction and reference any memory address.

Draw commands can be received from applications (including a subcomponent of an operating system that is responsible for creating the desktop) and be processed by graphics device interface 210. Graphics device interface 210 in general can include a process that can generate graphical object draw commands. Graphics device interface 210 in this example embodiment can be configured to pass its output to the display driver that is attached to the session.

When graphics subsystem 206 has processed the graphics API command received from application 202 to produce a result (such as a bitmap stored in a memory address), graphics subsystem 206 sends the result to virtual device driver 218. Virtual device driver 218 is a process that communicates with the output device 222 through a communications subsystem. When graphics subsystem 206 invokes a routine in virtual device driver 218, virtual device driver 218issues commands to the output device and an image is produced on that output device.

Virtual device driver 218 may communicate with wireless display surface 222 via, for instance, a Wireless USB connection or a Wireless Display (WiDi) connection (depicted as communication path 1). WiDi enables devices to create ad-hoc networks—to communicate with each other without prior setup or the use of separate wireless access points. In a common scenario, a source computer 226 and a wireless display surface 222 discover each other, with source computer 226 taking the role of a soft access point (“AP”). The wireless display surface 222 may participate in this operation of discovery through the use of a destination computer 224 that is connected to the wireless display surface 222 through a cable—such as a HDMI cable—or through a destination computer 224 that is built into the wireless display surface 222. After discovery, confirmation of creating a WiDi connection may be established through user input at source computer 226, such as pressing a particular button on a keyboard, or the input of a short alphanumeric code displayed on the wireless display surface 222.

Virtual device driver 218, audio driver 228 (which receives audio from application 202) and input driver 230 (which receives user input from a user device) communicate with remote presentation protocol (RPP) encoder 220. Graphics data from application 202 passes along communication channel 2 (between the application 202 and the graphics subsystem 206) and then communication channel 3 (between the graphics subsystem 206 and the virtual display driver 218). Audio commands generated from application 202 are passed from application 202 to audio driver 228 along communication channel 4. RPP encoder 220 is configured to compress screen data (including graphics, sound, and input) according to a RPP. While RPP encoder 220 is depicted here as receiving graphics data from graphics device interface 210, it may be appreciated that RPP encoder 220 may receive graphics data from a variety of areas within computer 226, such as a media file stored on a disk, a graphics command (like a DIRECTX command), a composition image from a graphics subsystem, or an animation image or command from an animation subsystem. A RPP used by RPP encoder 220 may to compress data, thereby improving the fidelity and/or interactivity of the data being presented.

Bandwidth may be conserved when encoding screen data with a RPP in a variety of ways. For instance, an image may be subdivided into tiles, and only those tiles that change between images (“dirty tiles”) may be sent. When tiles are received by a client, the client may cache the tiles, then the server may instruct the client to re-use cached tiles instead of the server sending identical tiles. Where windows are moved or scrolled, that information may be determined, and the server may instruct the client to re-use the identical information corresponding to that window move or scroll between a previously received image frame and a new image frame. Another way to conserve bandwidth is, rather than sending the graphical result of rendering a graphics command (such as a resultant bitmap image), the server may send the graphics commands themselves, which are then rendered by the client. Where graphics rather than graphics commands are sent, these graphics may be compressed, such as via a H.264 encoder, and a single desktop frame may be compressed with multiple codecs. For instance, the text on a computer desktop may be compressed with a first codec, whereas the images on that same computer desktop may be compressed with a second codec. These are some techniques that may be used by a RPP, but the techniques described herein do not make up an exhaustive list of such techniques.

Upon being encoded with RPP encoder 220, the encoded screen data (such as a specific window to be shared) is transmitted to wireless display computer 224 in adherence with the communication protocol with which source computer 226 and wireless destination computer 224 communicate(such as a IEEE 802.11n protocol). The encoded data transmitted across this communication channel appears on the channel to be remote presentation system data. That is, where the data is transmitted as a plurality of packets, each packet appears to be a RPP packet.

Destination computer 324 may comprise logic and/or circuitry configured to decode RPP data received from source computer 326. As depicted, destination computer comprises lightweight RPP decoder 334. Lightweight RPP decoder 334 may comprise a software process executed on a general purpose CPU that is receives RPP packets from a network interface of destination computer 324. Lightweight RPP decoder 334 is configured to decode received RPP data and display it on wireless display 322. Lightweight RPP 334 decoder may offload some of this decoding to hardware decoders, such as depicted HW decoders 332A and 332B. A hardware decoder may comprise, for example, specialized hardware configured to decode RemoteFX-encoded data or H.264-encoded data. Lightweight RPP decoder 334 may be considered lightweight because does not contain logic to process aspects of a conventional RPP session. For instance, Lightweight RPP decoder 334 may not contain logic to initiate or terminate a RPP session, to store and/or transmit user credentials to a RPP server to validate a RPP session, to encode screen data, or receive screen data including images, sounds, that is input locally at destination computer 324.

Interactivity may be further increased by assigning a priority to portions of a desktop that correspond to user input. This is because someone viewing a desktop may be drawn to those portions of the desktop that correspond to user input, so the rate at which these portions are updated may impact that person's impression of interactivity more than the rate at which other portions of the desktop are updated. This priority may be assigned in a variety of ways. For instance, where a frame of a desktop is subdivided into tiles, the tile or tiles that contains all or part of a user's cursor may be given an assigned priority. Also, for instance, where user input results in a change in the size, shape, or position of a window on the desktop (such as by the user using the cursor to drag a corner of a window), the tile or tiles that contain all or part of this changing window may be assigned a higher priority. A high priority may give screen data preference in how it is processed in a queue of the source computer or destination computer, such as being placed in a queue ahead of lower-priority screen data. These queues may include a quote of screen data to be encoded, decoded, or transmitted.

Source computer 226 may be able to encode images according to a variety of techniques, and do this based on attributes of destination computer 224 (such as destination computer 224's presence or lack thereof of hardware dedicated to decode a particular codec, the overall processing power of destination computer 224, destination computer 224's amount of RAM, whether and, if so, what type of GPU destination computer 224 possesses), as well as the communications network via which source computer 226 and destination computer 224 communicate. In a common scenario, source computer 226 may be a general purpose computer that, in addition to transmitting data to be displayed on wireless display 222 (along communication channel 5), may be used for other purposes concurrently, such as to execute a web browser or an e-mail client. In contrast, in this common scenario, destination computer 224 may be dedicated to decoding image data received from source computer 226 and displaying that decoded image on wireless display 222. Given that, in this scenario, processing resources of source computer 226 may be used for things other than encoding and transmitting data to destination computer 224, whereas destination computer 224 may be used exclusively or nearly exclusively for receiving, decoding, and presenting data received from source computer 226, it may be preferable for as much processing to be done as is possible on destination computer 224. Thus, the amount of encoding performed by source computer 226 may be determined based on a maximum decoding capability of destination computer 224. This may be accomplished, for instance, by when source computer 226 and destination computer 224 establish communication, destination computer 224 indicates to source computer 226 its capabilities to receive, decode and display image data.

This indication from destination computer 224 may comprise, for instance, one or more codecs that destination computer 224 may decode, as well as an indication of preference among those one or more codecs. For instance, the indication may state that destination computer 224 is capable of decoding both RemoteFX and H.264 formats, but prefers JPEG 2000 because it has specialized hardware to decode H.264, while it must decode RemoteFX with a general purpose CPU. Where a codec format allows for a variable amount of compression or quality (where a low amount of compression may be decoded more quickly but requires more bandwidth to transmit and a high amount of compression may not be decoded as quickly but requires less bandwidth to transmit), this indication from destination computer 224 may also include the degree of compression that destination computer 224 is capable of decoding.

This indication from destination computer 224 may also comprise other information about the ability of the destination computer to decode data encoded with a remote presentation protocol. For instance, where the remote presentation protocol may subdivide a desktop frame into tiles and instruct destination computer 224 to cache and re-use tiles, destination computer 224 may indicate to source computer 226 that it has a limited amount of memory with which to cache tiles.

Source computer 226 may receive this indication from destination computer 224 and from the indication and information about source computer 226, determine how to encode information with remote presentation encoder 220. For instance, while destination computer 224 may indicate a preference to use a particular format because it has hardware dedicated to decoding that format, that may be a particularly tough format for source computer 226 to encode, based on the particulars of the source computer 226 architecture. Given this information, source computer 226 may select a way to encode computer desktops with remote presentation encoder 220, and use this selected way to encode when encoding computer desktops to be sent to destination computer 224.

In another common scenario, while destination computer 324 is dedicated to decoding and presenting screen data received from source computer 326, destination computer 324 has limited processing resources because it is a low cost, embedded device. In this scenario, source computer 326 may attempt to overcome the limitations of destination computer 324 by performing a great deal of processing locally (such as classifying different parts of a computer desktop and encoding the different parts differently, to make decoding less resource intensive). However, because source computer 326 may also be executing user applications (such as those applications that make up the screen data that is being transmitted to destination computer 324), a favored situation may involve source computer 326 devoting as much processing resources to encoding screen data without denying the user applications any processing resources (e.g. only using otherwise available processing resources).

In another common scenario, the screen data may comprise a video with sound and source computer 226 may be in communication with destination computer 224 for the purpose of presenting the screen data on a home theater that includes wireless monitor 222. In such a scenario, as well as other scenarios, it may be important that the sound and video are played synchronously. In such a scenario, remote presentation encoder 220 may receive sound or audio data from an audio driver of source computer 226, encode this sound data and send it to destination computer 224 along with the image data of the video. Source computer 226 may further mark the sound and image data, such as with a time code, to signify what sound data synchronizes with what image data. Destination computer 224 may use this time code information so that it instructs wireless display 222, and an audio output means communicatively connected to destination computer 224 to both respectively play the sound and image synchronously.

This display of screen data by source computer 226 on wireless display 222 may be done according to a variety of paradigms relative to source computer 226's physical display or displays. For instance, wireless display 222 may mirror one or more of source computer 226's one or more physical displays. Wireless display 222 may also be used in a multi-mon configuration to extend the physical display of source computer 226. That is, the images displayed on wireless display 222 will not be displayed on any physical monitor of source computer 226.

FIG. 2A depicts the sessions on a server in an example computer system where a local user desktop is shared in a conventional remote presentation protocol (RPP) session. Server computer 280 is configured to serve remote presentation sessions. Server computer 280 comprises session 0 282, a non-interactive session (e.g. no user account is associated with the session by an operating system) that comprises a system service configured to encode and transmit RPP data generated by user sessions. Note that the depiction of session 0 282 is exemplary, and there are other system architectures and embodiments where the present invention may be implemented. Server computer 280 also comprises user console session 286, an interactive user session for the user at the console (e.g. it receives input from the local mouse and keyboard, rather than input across a communications network in a RPP session, and displays output on local monitors and speakers). Server computer 280 also comprises remote user session 288, a user session created on server computer 280 when server computer 280 and client computer 282 establish a RPP session across communications network 290.

Remote user session 288 is the user session that communicates with client computer 282 in the RPP, but it is the local screen that's to be shared (or mirrored or duplicated) with client computer 282, and that local screen is associated with a different user session—user console session 286. To share the local screen with client computer 282, remote user session 288 receives input from client computer 282 and transmits that user input to user console session 286, where it is processed. Likewise, the screen data that user console session 286 creates is received by remote user session 288. Remote user session 288 takes that screen data, and sends it to session 0 282 for it to be encoded with a RPP and transmitted to client computer 282 for display. In the depicted embodiment, user console session 286 does not interact with session 0 282 for the purpose of encoding screen data with a RPP and transmitting it to client computer 282. That process is handed by remote user session 288.

FIG. 2B depicts the sessions on a server in an example computer system where a local user desktop is displayed on a wireless display. In contrast to the conventional RPP session depicted in FIG. 2A, there is no additional user session created for transmitting data (the remote user session 288 of FIG. 2A). Rather, the connection with destination computer 294 is managed by user console 286b of source computer 292, which also manages the encoding of screen data by session 0 282b (note that, as with FIG. 2A, session 0 is not mandatory, and the present invention may function in different system architectures). User console session 286 and destination computer 294 establish a wireless communication channel through communication network 290. The user console session 286b generates local screen data, such as a computer desktop. User console session 286b sends instructions to session 0 282b to encode that screen data with a RPP and transmits this encoded screen data directly to destination computer 294—it does not pass through a second user console, like how remote user session 288 of FIG. 2A is involved in the RPP data transmission in FIG. 2A.

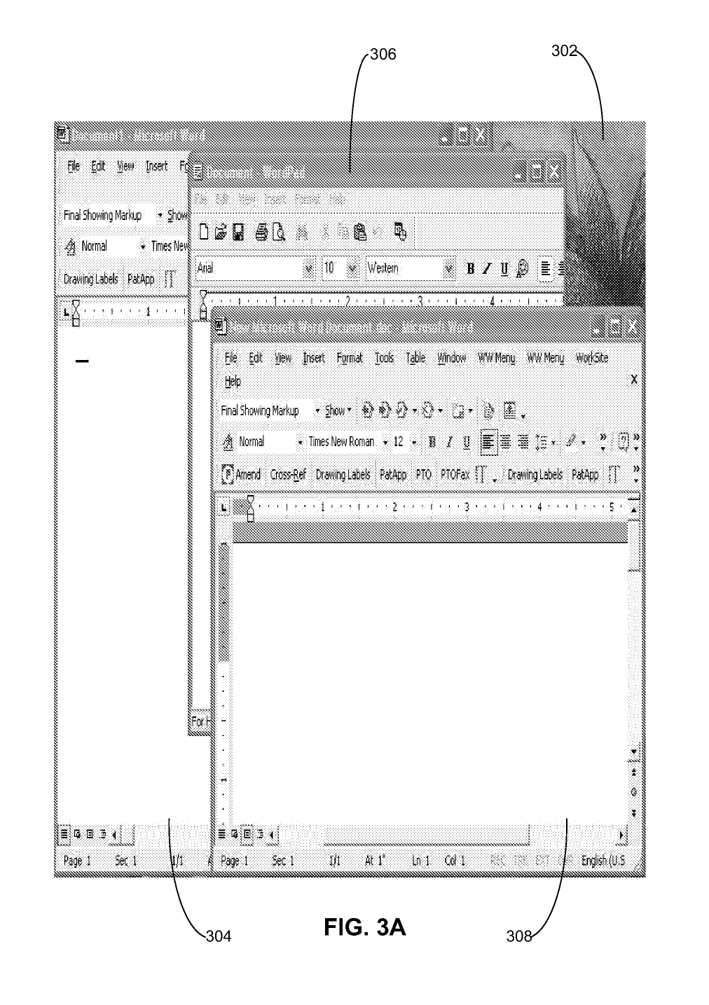

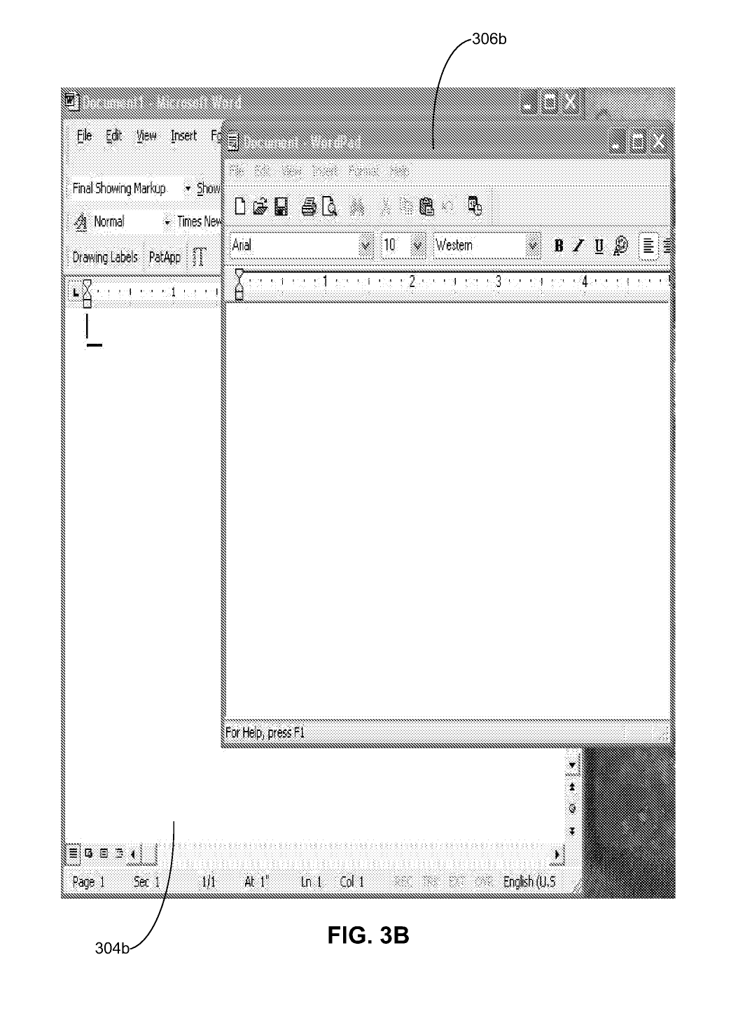

FIGS. 3A and 3B depict a computer desktop where only specific windows are shared with a wireless display. FIG. 3A depicts a computer desktop of a source computer (such as source computer 226 of FIG. 2) that comprises a plurality of windows, wherein specific windows—a subset of the plurality of windows are to be shared. This may be implemented via, for example, the system depicted in FIG. 2. Computer desktop 302 comprises a plurality of windows—shared window 304, shared window 306, and non-shared window 308. It may be noted that each window intersects with at least one other window—for instance, shared window 306 occludes shared window 304, and itself is occluded by non-shared window 308.

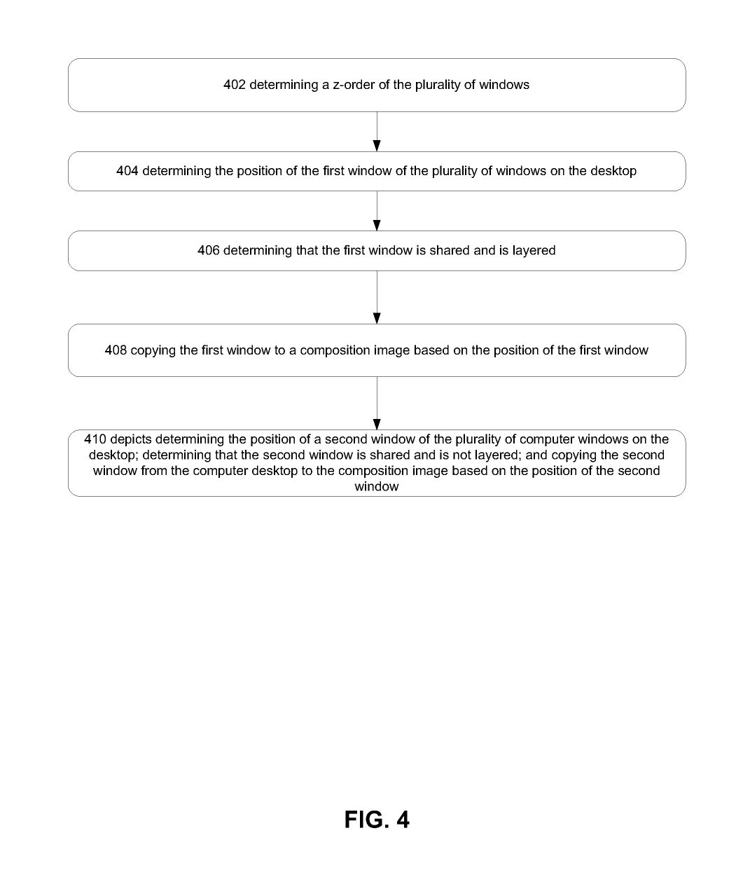

FIG. 3B depicts the specific windows of the computer desktop of FIG. 3A that are shared with a destination computer (such as destination computer 224 of FIG. 2) and displayed on a wireless display (such as wireless display 222 of FIG. 2) using the present techniques. This techniques may be implemented via, for example, the system depicted in FIG. 2. Composition image 302b comprises shared window 304b and shared window 306b. All of shared window 306b is displayed, including those parts of window 306 that are occluded by non-shared window 308 in FIG. 3A. This is because the occluded portion of window 306 was able to be determined using the techniques as described with respect to FIG. 4. Shared window 304b, being partly occluded by shared window 306b is not shown in its entirety. Those portions of shared window 304b that are covered by shared window 306b are not shown because shared window 306b is on top of shared window 304b on the computer desktop. However, those portions of shared window 304b that were covered by non-shared window 308b on the computer desktop are now shown.

In a scenario for the present invention, shared windows 304 and 306 may comprise windows for a media player application that are to be presented on a wireless display, and non-shared window is a window that a user of the source computer does not want presented on a wireless display, such as a word processor window. In this fashion, people viewing the wireless display may view a video without it being covered, and the user of source computer may still do some work in a word processor at the same time.

FIG. 4 depicts example operational procedures for removing occlusions from specific windows that are shared. The techniques of FIG. 4 may be implemented to take the computer desktop of FIG. 3A and share from it the specific windows depicted in FIG. 3B. This may be implemented via, for example, the system depicted in FIG. 2.

A window is shared where it is designated to be sent to a destination computer. This designation may occur, for example, in response to user input at the source computer of specific windows or applications to share with the destination computer, so that they are displayed on the wireless display. A window is layered where it is designated as such, and so the entire window is stored in a memory area separate from where the desktop is stored (and this window may be occluded on the desktop, so the entire window cannot be determined from the desktop).

In an embodiment, a window in a desktop may have the following characteristics—(1) it is both shared and layered; (2) it is shared but not layered; (3) it is not shared, and it occludes a portion of a shared window, and that occluded portion can be determined; and (4) it is not shared and it occludes no portion of a shared window.

In an embodiment, a composition image is generated—a blank canvas upon which the windows to be shared are drawn—and then two passes of the windows are made to draw the shared windows to the composition image as they are arranged on the desktop.

In a first pass through the windows, each window is checked for three things. First, each window is checked to determine its z-order (the depth of the window on the desktop; a window with a lesser z-depth will occlude a window with a greater z-depth where the two windows occupy the same position on the desktop). Second, each window is checked to determine whether it is shared, and if so, whether part of it is occluded. Regions of the composition image are designated as shared and occluded or shared but not-occluded as this is determined in the pass through the windows. Third, and finally, each window is checked to determine the position in the composition image where the window would be rendered if it was rendered in the composition image. Since the composition window has the same dimensions as the desktop, this position may be determined by offsetting the window with the coordinates of the upper left corner for the desktop. This position for each window may be referred to as that window's target coordinates.

A shared but not-occluded region of the composition image is one where a shared window is to be added, and that portion of the window can be determined. It may be determined either (1) because it is not occluded by another window on the desktop; or (2) because it is occluded by another window on the desktop, but that region of the shared window may be determined due to being stored in some memory area separate from the memory area where the desktop is stored.

Having made the first pass, a second pass through each window is made, starting with the window with greatest z-depth, and progressing through the windows in order of decreasing z-depth. Each window is processed according to its characteristics, as described above. If the window is both shared and layered, the window is copied to the target coordinates of the composition image from a memory area where the window is stored (separate from a memory area where desktop is stored; this may be referred to as a window buffer; it may comprise a portion of system memory). The area occupied by this window is added to the shared non-occluded area.

If the window is shared, but not layered, the portion of the window rendered (and thus, visible) in the memory area where the desktop is stored is copied to the composition image at the target coordinates for this window. If the window is partially occluded on the desktop, not all of it will be rendered, so not all of it will be copied to the composition image. If the window is not shared, and it does not intersect either the occluded or the shared non-occluded area, nothing is added to the composition image.

Having made the second pass, the composition image now comprises the shared non-occluded windows (portions of which may be occluded by other shared windows). The composition image is then encoded (for instance, compressed) and sent to the client for display on a display device of the client.

It may be appreciated that there are techniques that achieve similar results that do not incorporate exactly two passes through the windows. For instance, the operations of determining a z-order of the windows, and determining the shared non-occluded and shared occluded regions of the composition image may be performed in separate passes.

These techniques described with respect to FIG. 4 are described in greater detail with respect to operations 402-410, below. While the operations of FIG. 4 discuss four windows, it may be appreciated that the present techniques may be applied to any number of windows, in any state of being shared and/or occluded, and in any z-order.

Operation 402 depicts determining a z-order of the plurality of windows, wherein a first window has a largest z-distance of the plurality of windows. Windows may be thought of as having a z-order on the desktop—a window with a greater z-distance will be occluded by a window with a smaller z-distance. In the operations described below, the windows may be processed by traversing them in z-order, starting with the window with the greatest z-distance, and concluding with the window with the least z-distance.

In an embodiment, a window's z-distance may be stored in its meta-data, or by some managerial part of a system that manages these windows, such as an operating system. In such an embodiment, each window's z-distance may be determined by checking the location where it is stored.

Operation 404 depicts determining the position of the first window of the plurality of computer windows on the desktop. As with operation 402, this information may be stored in a window's meta-data, or by some managerial part of a system that manages these windows.

In an embodiment, operation 404 includes determining the position of the first window based on a shared window position of the first window relative to the computer desktop. This may be done utilizing the target coordinates of the first window, as described above.

Operation 406 depicts determining that the first window is shared and is layered. It may be determined that a window is shared by checking a flag of the window set by a user of the server to denote that that window is to be shared. It may be determined that a window is layered by checking meta-data associated with the window to see that a “layered flag,” such as the WS_EX_LAYERED flag in MICROSOFT WINDOWS, or similar indicator is set.

Operation 408 depicts copying the first window to a composition image based on the position of the first window. To display to the client the shared windows in the same arrangement as they are on the server, the arrangement of the shared windows must be known. Where the composition image comprises the same dimensions as the desktop from which the windows are shared, then this may be done, for instance, by using the relative position of the shared window to the desktop. For example, if the shared window has an upper left corner located 70 pixels to the right and 60 pixels below the upper left corner of the desktop, then relative position of the first window may be maintained in the composition image by copying it such that the upper left corner of the first window is located 70 pixels to the right and 60 pixels below the upper left corner of the composition image.

In an embodiment, the composition image comprises a bitmap image. A variety of other image formats may be used, such as Joint Photography Experts Group (JPEG), or Graphics Interchange Format (GIF).

In an embodiment, operation 408 includes disabling desktop composition for each window of the plurality of computer windows before copying a window to the composition image. Applications in some operating systems, such as a MICROSOFT WINDOWS VISTA operating system, with its Desktop Window Manager (DWM), do not draw windows directly to the memory area for the desktop. Instead, those windows are drawn to off-screen memory areas in video memory, which are then rendered into a desktop image. In some implementations that incorporate such a desktop composition feature, when shared windows are drawn to these off-screen memory areas, they are drawn without the border frame of the window, and that border is drawn around the window when it is later drawn to the memory area for the desktop. In this case, retrieving a shared window from these off-screen memory areas would lead to retrieving a partial shared window, since that window would lack its frame border. This issue may be mitigated by disabling those desktop composition features.

In an embodiment, operation 408 includes setting a layering flag for each window of the plurality of computer windows that is shared before copying any shared window to the composition image. In some operating systems, layered and non-layered windows are handled differently. If a window is not layered, it is drawn only to the memory area for the desktop, and those portions of the window that are occluded by another window are not drawn at all. If a window is layered, the entire window is drawn to an off-screen memory area, where it is stored, and then the non-occluded portion of the window (which may be the entire window) is drawn to the memory area for the desktop. As such, by setting a layering flag for each shared window in environments which support such an operation, those portions of shared windows that are occluded may made available in memory to transmit to a client, though they are not viewable on the server's desktop.

In an embodiment, operation 408 includes copying the first window from a window buffer to the composition image. This window buffer may comprise an off-screen memory area as discussed with respect to operation 406. In an embodiment where a layered window is stored in the off-screen memory area, it may be copied to the composition image so that the entire window is copied to the composition image even if some part of the window is occluded on the desktop.

Operation 410 depicts determining the position of a second window of the plurality of computer windows on the desktop; determining that the second window is shared and is not layered; and copying the second window from the computer desktop to the composition image based on the position of the second window. In an embodiment using a MICROSOFT WINDOWS operating system, this may be effectuated, for instance, through a call to the GetWindowDC( ) function.

Where the second window is shared, it is to be copied to the composition image for transmittal to the client. Where it is not layered (such as where the layered flag for the second window is not set), it may be that the second window is stored in memory only in the memory area for the desktop. In such a case, it may be retrieved from the memory area for the desktop and from there copied to the composition image.

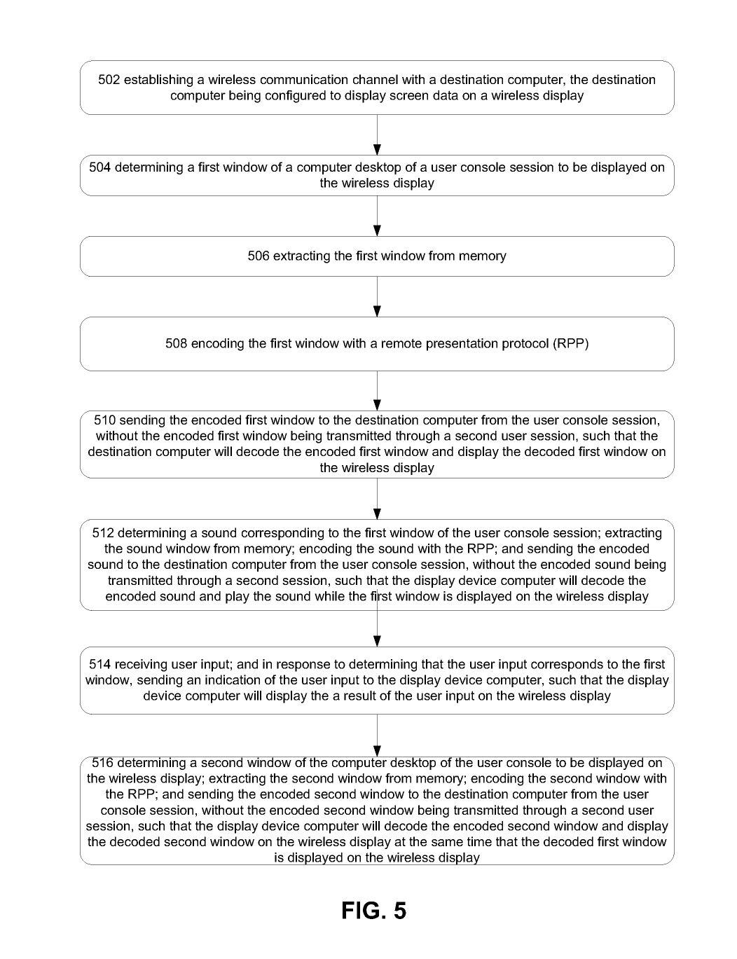

FIG. 5 depicts example operational procedures for displaying images on a wireless display. The operational procedures of FIG. 5 may be implemented on the computer system of FIG. 2. It may be appreciated that the order of operations is not mandatory, but the present invention may be implemented with varying permutations of the order of operations, and that not every operation needs to be performed to implement the present invention. In the operational procedures of FIG. 5, source computer determines screen data, including one or more specific windows of a computer desktop, to share with a destination computer, extracts those windows from a memory of the source computer (such as a memory where the computer desktop is stored, or a memory where each window is buffered) then encodes and sends that computer desktop to the destination computer (such as destination computer 224 of FIG. 2) with a remote presentation protocol (RPP), which decodes it and displays it on a wireless display (such as wireless display 222 of FIG. 2). This process of encoding and decoding computer graphics or screen data is performed with a RPP, though this encoding and decoding may occur outside of a remote presentation session (e.g. a remote presentation session may not be established at the beginning of the operational procedures, there may be no validation of user credentials, a separate user session may not be created, and a remote presentation session may not be terminated at the end of the operational procedures). Through implementing these operational procedures, a high level of fidelity and interactivity is provided through the wireless display, making it very similar to the level of fidelity and interactivity offered by a wired display.

The operational procedures begin with operation 502. Operation 502 depicts establishing a wireless communication channel between a user console session of a source computer and a destination computer, the destination computer being configured to display screen data (such as a computer desktop) on a wireless display. This wireless communication channel may comprise, for instance, a Wireless USB or Wireless HD communication channel. The communication channel may be established between a source computer (such as source computer 226 of FIG. 2) and a destination computer (such as destination computer 224 of FIG. 2). The destination computer may comprise an ASIC embedded within a wireless display, or a computer physically coupled to a wireless display, such as an embedded system “set top box.” The destination computer may comprise specialized circuitry apart from a general purpose processor that is configured to decode remote presentation data and render graphics on the wireless display.

Operation 504 depicts determining a first window of a computer desktop of the user console session to be displayed on the wireless display. This may be determined, for instance, in response to user input of one or more windows, or one or more applications (and that application's windows) to be shared.

Operation 506 depicts extracting the window from the computer desktop. This may be done, for instance, by implementing the operational procedures depicted in FIG. 4. In an embodiment wherein the first window is occluded by a second window on the computer desktop, operation 506 may comprise determining the position of the first window on the computer desktop; determining that the first window is shared and is layered; and copying the first window from a window buffer to a composition image based on the position of the first window, the window buffer storing the first window separate from the computer desktop. These operations may be performed in a manner similar to as described with respect to FIG. 4.

In an embodiment, operation 506 may comprise determining the position of the first window on the computer desktop; determining that the first window is shared and is not layered; and copying the first window from the computer desktop to a composition image based on the position of the second window. These operations may be performed in a manner similar to as described with respect to FIG. 4.

Operation 508 depicts encoding the first window with a remote presentation protocol (RPP). This process of encoding the first window may occur outside of a remote presentation session in that a remote presentation session may not be established at the beginning of the operational procedures, there may be no validation of user credentials, and/or a remote presentation session may not be terminated at the end of the operational procedures. The encoded first window may comprise, for instance, an image encoded with a H.264 format. Where the wireless destination computer caches screen data that it receives from the source computer, the encoded first window may itself not contain encoded graphics data, but rather an indication for the wireless destination computer to fetch a particular cached data from its cache. Where the remote presentation session protocol subdivides screen data into a plurality of tiles, it may be that operation 506 comprises encoding some tiles of the first window and sending those to wireless display computer along with an indication for the wireless destination computer to fetch one or more tiles from its cache.

Operation 510 depicts sending the encoded first window to the destination computer from the user console session, without the encoded first window being transmitted through a second user session, such that the destination computer will decode the encoded first window and display the decoded first window on the wireless display. The source computer and destination computer communicate over the established wireless communication channel. When the source computer sends the encoded first window to the destination computer, it does so using this communication channel, but it does not first establish a remote presentation session across this communication channel before doing so. In response to receiving the encoded first window, the destination computer decodes the data and assembles it on the wireless display. While the decoded first window corresponds to the first window, it may not exactly match the first window. For instance, if the first window is encoded and then decoded with a lossy codec, some of the image will be lost, and the decoded first window will be different from than first window.

Operation 512 depicts determining a sound corresponding to the first window of the user console session; extracting the sound window from memory; encoding the sound with a remote presentation protocol; and sending the encoded sound to the destination computer from the user console session, without the encoded sound being transmitted through a second user session, such that the destination computer will decode the encoded sound and play the sound while the first window is displayed on the wireless display. Where specific windows are shared and some of those windows have corresponding sounds (such as a window comprises a window in which a video is playing), that sound may be transmitted to the destination computer for play via speakers communicatively coupled to the destination computer. Sounds from un-shared windows or processes without windows may also be played on the source computer. In such a scenario, only the sounds that correspond to the shared windows are transmitted to the destination computer. This may be accomplished, for instance, by intercepting sound data and commands sent from the applications with shared windows and intended for an audio driver, and instead transmitting them to a virtual audio driver, from which they are encoded by the remote presentation encoder and transmitted to the destination computer and played.

Operation 514 depicts receiving user input at the user console session; and in response to determining that the user input corresponds to the first window, sending an indication of the user input to the destination computer, such that the destination computer will display the a result of the user input on the wireless display. Where only specific windows are shared with the destination computer, user input at the source computer may be thought of as being in one of two groups: user input that affects one of the specific windows, and user input that does not affect one of the specific windows. For instance, input that affects one of the specific windows may comprise user input that changes the shape of one of those specific windows, and input that does not affect one of the specific windows may comprise user input of text into a word processor window that is not shared. The source computer may use this distinction in determining what input to indicate to the destination computer, such as by conveying indications of user input that relate to the specific shared windows, and not conveying indications of user input that do not relate to the specific shared windows.

Operation 516 depicts determining a second window of the computer desktop of the user console session to be displayed on the wireless display; extracting the second window from memory; encoding the second window with the RPP; and sending the encoded second window to the destination computer from the user console session, without the encoded sound being transmitted through a second user session, such that the destination computer will decode the encoded second window and display the decoded second window on the wireless display at the same time that the decoded first window is displayed on the wireless display. Operation 516 may be effectuated in a similar manner as how the operations of FIG. 4 are used to derive the shared windows of FIG. 3B from the computer desktop of FIG. 3A. For instance, the first window may be window 304 of FIG. 3A and the second window may be window 306 of FIG. 3B. The first window and the second window may be windows of the same application. For instance, in a media application, the first window may comprise a window in which a video is displayed and the second window may comprise a window that contains control buttons for the media player.

### CONCLUSION

While the present disclosure has been described in connection with the preferred aspects, as illustrated in the various figures, it is understood that other similar aspects may be used or modifications and additions may be made to the described aspects for performing the same function of the present disclosure without deviating there from. Therefore, the present disclosure should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method for displaying images on a wireless display with high fidelity and interactivity, comprising:
establishing a wireless communication channel between a user console session of a source computer and a destination computer, the destination computer being configured to display images on a wireless display;
determining a first window of a computer desktop of the user console session to be displayed on the wireless display;
extracting the first window from memory;
encoding the first window with a remote presentation protocol (RPP); and
sending the encoded first window to the destination computer from the user console session, without the encoded first window being transmitted through a second user session, such that the destination computer will decode the encoded first window and display the decoded first window on the wireless display.

2. The method of claim 1, further comprising:
determining a sound corresponding to the first window of the user console session;
extracting the sound window from memory;
encoding the sound with the RPP; and
sending the encoded sound to the destination computer from the user console session, without the encoded sound being transmitted through a second user session, such that the destination computer will decode the encoded sound and play the sound while the first window is displayed on the wireless display.

3. The method of claim 1, further comprising:
receiving user input at the user console session; and
in response to determining that the user input corresponds to the first window, sending an indication of the user input to the destination computer, such that the destination computer will display the a result of the user input on the wireless display.

4. The method of claim 1, further comprising:
determining a second window of the computer desktop of the user console session to be displayed on the wireless display;
extracting the second window from memory;
encoding the second window with the RPP; and
sending the encoded second window to the destination computer from the user console session, without the encoded second window being transmitted through a second user session, such that the destination computer will decode the encoded second window and display the decoded second window on the wireless display at the same time that the decoded first window is displayed on the wireless display.

5. The method of claim 4, wherein the first window and the second window are windows of the same application.

6. The method of claim 1, wherein the first window is occluded by a second window on the computer desktop, and wherein extracting the first window comprises:
determining the position of the first window on the computer desktop;
determining that the first window is shared and is layered; and
copying the first window from a window buffer to a composition image based on the position of the first window, the window buffer storing the first window separate from the computer desktop.

7. The method of claim 1, further comprising:
determining the position of the first window on the computer desktop;
determining that the first window is shared and is not layered; and
copying the first window from the computer desktop to a composition image based on the position of the second window.

8. A system for displaying images on a wireless display with high fidelity and interactivity, comprising:
a processor; and
a memory communicatively coupled to the processor, the memory bearing instructions that, when executed on the processor, cause the processor to perform operations comprising:
establishing a wireless communication channel between a user console session of a source computer and a destination computer, the destination computer being configured to display images on a wireless display;
determining a first window of a computer desktop of the user console session to be displayed on the wireless display;
extracting the first window from memory;
encoding the first window with a remote presentation protocol (RPP); and
sending the encoded first window to the destination computer from the user console session, without the encoded first window being transmitted through a second user session, such that the destination computer will decode the encoded first window and display the decoded first window on the wireless display.

9. The system of claim 8, wherein the memory further bears instructions that, when executed on the processor, cause the processor to perform operations comprising:
determining a sound corresponding to the first window of the user console session;
extracting the sound window from memory;
encoding the sound with the RPP; and
sending the encoded sound to the destination computer from the user console session, without the encoded sound being transmitted a second user session, such that the destination computer will decode the encoded sound and play the sound while the first window is displayed on the wireless display.

10. The system of claim 8, wherein the memory further bears instructions that, when executed on the processor, cause the processor to perform operations comprising:
receiving user input at the user console session; and
in response to determining that the user input corresponds to the first window, sending an indication of the user input to the destination computer, such that the destination computer will display the a result of the user input on the wireless display.

11. The system of claim 8, wherein the memory further bears instructions that, when executed on the processor, cause the processor to perform operations comprising:
determining a second window of the computer desktop of the user console session to be displayed on the wireless display;
extracting the second window from memory;
encoding the second window with the RPP; and
sending the encoded second window to the destination computer from the user console session, without the encoded sound being transmitted through a second user session, such that the destination computer will decode the encoded second window and display the decoded second window on the wireless display at the same time that the decoded first window is displayed on the wireless display.

12. The system of claim 11, wherein the first window and the second window are windows of the same application.

13. The system of claim 8, wherein the first window is occluded by a second window on the computer desktop, and wherein extracting the first window comprises:
determining the position of the first window on the computer desktop;
determining that the first window is shared and is layered; and
copying the first window from a window buffer to a composition image based on the position of the first window, the window buffer storing the first window separate from the computer desktop.

14. The system of claim 8, wherein the memory further bears instructions that, when executed on the processor, cause the processor to perform operations comprising:
determining the position of the first window on the computer desktop;
determining that the first window is shared and is not layered; and
copying the first window from the computer desktop to a composition image based on the position of the second window.

15. A computer-readable storage medium for displaying images on a wireless display with high fidelity and interactivity, bearing computer-readable instructions that, when executed on a computer, cause the computer to perform operations comprising:
establishing a communication channel between a user console session of a source computer and a destination computer, the destination computer being configured to display images on a display;
determining a first window of a computer desktop of the user console session to be displayed on the display;
extracting the first window from memory;
encoding the first window with a remote presentation protocol (RPP); and
sending the encoded first window to the destination computer from the user console session, without the encoded first window being transmitted through a second user session, such that the destination computer will decode the encoded first window and display the decoded first window on the display.

16. The computer-readable storage medium of claim 15, wherein the memory further bears instructions that, when executed on the processor, cause the processor to perform operations comprising:
determining a sound corresponding to the first window of the user console session;
extracting the sound window from memory;
encoding the sound with the RPP; and
sending the encoded sound to the destination computer from the user console session, without the encoded sound being transmitted a second user session, such that the destination computer will decode the encoded sound and play the sound while the first window is displayed on the display.

17. The computer-readable storage medium of claim 15, wherein the memory further bears instructions that, when executed on the processor, cause the processor to perform operations comprising:
receiving user input at the user console session; and
in response to determining that the user input corresponds to the first window, sending an indication of the user input to the destination computer, such that the destination computer will display the a result of the user input on the display.

18. The computer-readable storage medium of claim 15, wherein the memory further bears instructions that, when executed on the processor, cause the processor to perform operations comprising:
determining a second window of the computer desktop of the user console session to be displayed on the display;
extracting the second window from memory;
encoding the second window with the RPP; and
sending the encoded second window to the destination computer from the user console session, without the encoded sound being transmitted through a second user session, such that the destination computer will decode the encoded second window and display the decoded second window on the display at the same time that the decoded first window is displayed on the display.

19. The computer-readable storage medium of claim 15, wherein the first window is occluded by a second window on the computer desktop, and wherein extracting the first window comprises:
determining the position of the first window on the computer desktop;
determining that the first window is shared and is layered; and
copying the first window from a window buffer to a composition image based on the position of the first window, the window buffer storing the first window separate from the computer desktop.

20. The computer-readable storage medium of claim 15, wherein the memory further bears instructions that, when executed on the processor, cause the processor to perform operations comprising:
determining the position of the first window on the computer desktop;
determining that the first window is shared and is not layered; and
copying the first window from the computer desktop to a composition image based on the position of the second window.
